(19) United States
(12) Patent Application Publication
(10) Pub. No.: US 2007/0153084 A1
(43) Pub. Date: Jul. 5, 2007

(54) Semiconductor wafer reader and illumination system

(76) Inventors: George Deveau, Cumming, GA (US); Robert Blenis, Roswell, GA (US)

Correspondence Address: COGNEX CORPORATION;INTELLECTUAL PROPERTY DEPARTMENT, 1 VISION DRIVE, NATICK, MA, 01760-2077, US

(21) Appl. No.: 11/322,369

(22) Filed: Dec. 30, 2005

(51) Int. Cl. H04N 7/18

(52) U.S. Cl. 348/126; 348/131

(57) ABSTRACT

A reader for semiconductor wafers includes a camera for reading a mark on a semiconductor wafer. The wafer is positioned adjacent a surface of the housing including a reading window and an illumination device. The illumination device provides both bright and dark field illumination to the wafer, and light reflected from the wafer is directed to a mirror inside the housing, which directs the light along a camera axis to a lens of the camera. The alignment of the reflected illumination can be adjusted by changing the angle of the single mirror within the reader, thereby limiting the complexity of the device. The illumination device can be an array of light emitting diodes arranged in rows. The rows are separated by baffles which restrict dispersion of light from the light emitting diodes to provide directed bright field illumination.

### BACKGROUND OF THE INVENTION

The invention relates to a method and apparatus for reading identification marks on semiconductor wafers.

Semiconductor wafers used in the manufacture of integrated circuits are often marked with identification marks or other identifying information to facilitate tracking during production of semiconductor chips. These identifying marks, known as scribe marks, typically comprise a series of characters, bar codes, or other two-dimensional codes, each of which is formed from depressions in the substrate.

To provide an efficient production process, these marks must be reliably read by automated process equipment. In typical systems, a camera forms an image of the scribe mark, and converts the image into a digital format. The digitized image is then interpreted using, for example, optical character recognition or decoding software that determines letters, numbers, bar codes, or other symbols in the digitized image. For the mark to be properly interpreted by the software, however, the digitized image must be relatively clear. The image, therefore, must include adequate contrast between the background and the remainder of the mark.

Forming a clear image of the scribe mark, however, can be difficult for a number of reasons. First, because typical scribe marks comprise a group of relatively shallow depressions in the substrate, and the marks are of the same color as the substrate background, the marks can be hard to differentiate. Furthermore, the substrates are typically highly polished and, therefore, reflect a large amount of light into the camera, which tends to obscure the mark. Additionally, during chip production, material coatings, etching sequences, and other process steps adversely affect the marking, decreasing the quality of marking as the production process proceeds.

The optical properties of the wafer surfaces, moreover, can vary not only from wafer to wafer but also across the surface of an individual wafer. Imperfect formation or etching of the layers can also lead to variations in the thickness of the layers, which can produce artifacts in the image. Furthermore, materials used to treat or coat wafers, particularly photoresist, can accumulate in the depressions of the scribe marks, further obscuring the mark by affecting the optical properties of the substrate surface and scribe marks.

Because the problems described above make it difficult to form a clear image of the scribe marks, optical systems providing various lighting conditions, and particularly both dark and bright field illumination, have been developed. These systems typically include both a bright field light source and a dark field light source. The bright field light source provides a light to the wafer surface via a beam splitter and associated mirror system, which reflects the light in a direction normal to the surface of the wafer. A mirror re-directs light from the surface of the wafer back to the beam splitter, which reflects light from the mirror to a camera. A separate dark field light source is directed to the surface of wafer at an angle that is not normal to the surface of the wafer. The scribe imperfections in the surface of the wafer scatter the dark field light and reflect some light in a direction normal to the surface of the wafer. The mirror assembly re-directs this light to the beam splitter, which directs it to the camera. Since the mirror assembly and beam splitter redirect light reflected from the scribe back to the camera, the dark field light source causes the background of the scribe to look dark and the scribe itself to look bright.

Illumination systems of this type have been largely successful in providing efficient wafer reading systems. However, these prior art systems require elaborate optical components to direct bright field illumination directly coincident with the reflected illumination path. Therefore, these prior art systems are complicated, difficult to construct, and expensive. The present invention addresses these problems.

### BRIEF SUMMARY OF THE INVENTION

The present invention provides a reader for optically reading a scribe or mark on a semiconductor wafer that is effective, simple to construct and inexpensive. An illumination device providing both bright and dark field illumination is provided on a surface reader and is arranged to illuminate the scribe or mark. Angled light reflected from the wafer is directed through a reader aperture to a reflector inside the reader. The reflector is angled to direct the light toward a camera including an image sensor, which acquires an image of the mark or scribe. The reader images the mark, and decodes the mark or scribe.

In one aspect, the present invention provides an optical wafer reader including a camera having a camera axis substantially parallel to the wafer surface, an illumination device disposed on the surface of the reader facing the wafer surface and aimed to illuminate a mark on the wafer with bright and dark field illumination, a window in the surface of the reader facing the wafer surface for passage of light reflected off of the mark, and a reflector positioned to receive illumination reflected from the wafer and to direct the light along the camera axis.

In another aspect of the invention, the illumination device comprises an array of light emitting diodes arranged in a plurality of rows. A baffle can be positioned between each of the adjacent rows of light emitting diodes that are adapted to direct the light emitted from the light emitting diodes to provide bright field illumination to direct the light and limit light dispersion. A diffusing cover can also be provided over the light emitting diodes producing bright field illumination to disperse the light in a more uniform fashion.

In another aspect of the invention, the optical wafer reader can include a gear assembly for adjusting a focus of the camera. The reflector, moreover, can be pivotally mounted to the housing opposite the camera, and both the gear assembly and pivotal mounting of the reflector can be adjusted through devices accessed externally to the housing.

In yet another aspect, the present invention provides an optical wafer reader including a housing including a reader aperture positionable adjacent a semiconductor wafer for reading a mark on the wafer, a camera including a lens coupled to the housing, and a mirror pivotally coupled to an opposing end of the housing and configured to reflect light from the reader aperture toward the lens of the camera. An array of light emitting diodes are coupled to the housing adjacent the reader aperture and are adapted to provide bright and dark field illumination to the wafer positioned below the reader aperture such that light reflected from the wafer is directed by the mirror along a camera axis substantially parallel to the reading aperture.

In yet another aspect of the invention, an optical wafer reader is provided including a housing having a reflector pivotally coupled to a first end and a camera coupled to an opposing end. A light emitting device is coupled to a bottom of the housing, and a reading aperture provided in the bottom of the housing adjacent the first end of the housing and adjacent the light emitting device. The reflector is pivotally adjustable to direct light reflected through the reading aperture along a camera axis parallel to the bottom surface of the housing and toward a lens of the camera.

These and other aspects of the invention will become apparent from the following description. In the description, reference is made to the accompanying drawings that form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a perspective view of a semiconductor wafer reader constructed in accordance with the present invention;

FIG. 2 is a bottom plan view of the semiconductor reader of FIG. 1;

FIG. 3 is a side perspective view of the semiconductor reader of FIG. 1, with the sides removed;

FIG. 4 is a perspective view of the semiconductor reader of FIG. 1 at a different angle from FIG. 3, and with additional parts removed to illustrate the internal reflective components;

FIG. 5 is an exploded view of the illumination device of the semiconductor wafer reader of FIG. 1;

FIG. 6 is a cutaway view of the reader of FIG. 1 taken along the line 6-6 of FIG. 2; and

FIG. 7 is an end view of the reader of FIG. 6;

### DETAILED DESCRIPTION OF THE INVENTION

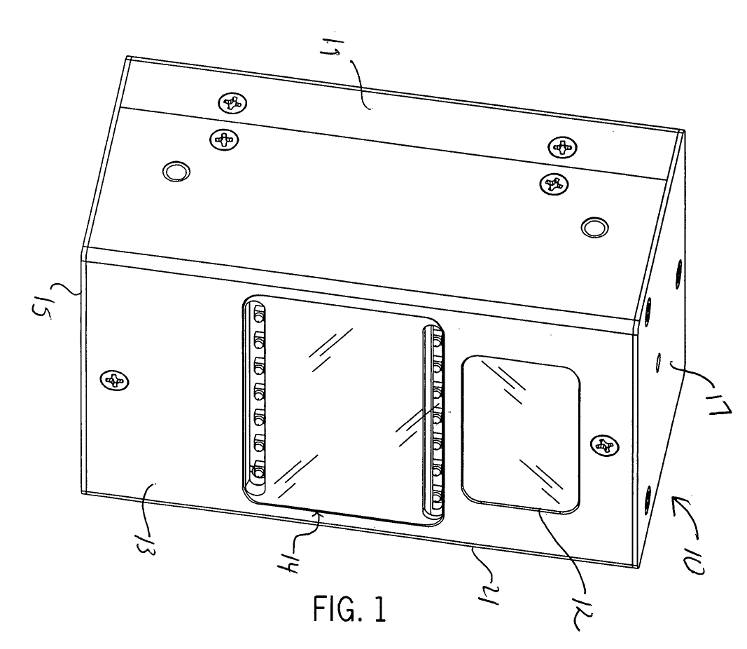

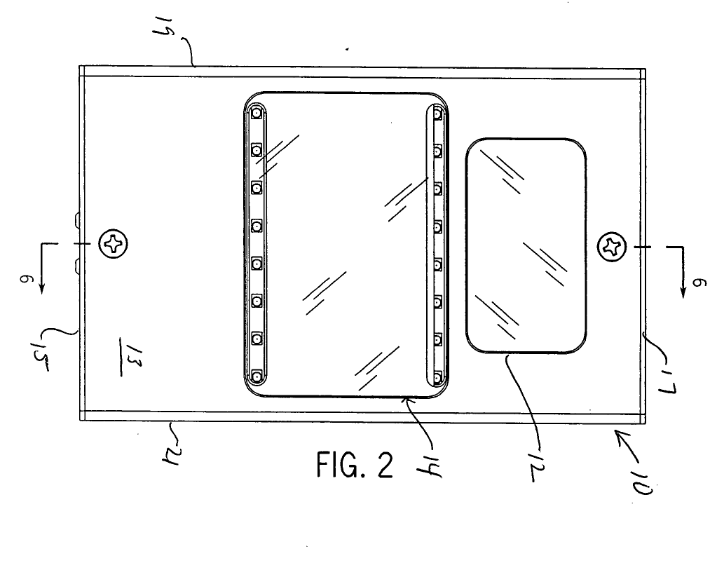

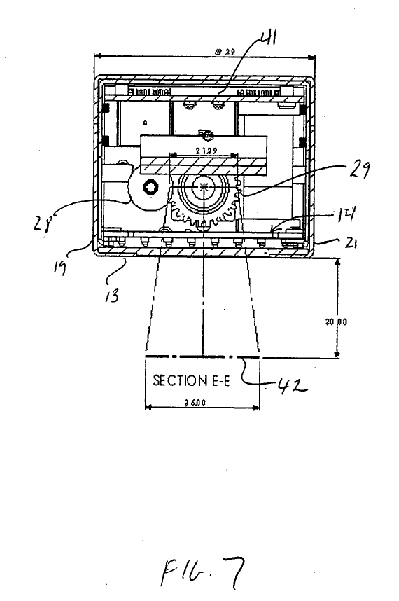

Referring now to the figures and more particularly to FIGS. 1 and 2, a wafer reader 10 constructed in accordance with the present invention is shown. The wafer reader 10 comprises a housing 11, with a reading window 12 and illumination device 14 provided in a bottom surface 13. A semiconductor wafer 42 (FIG. 7) is positionable adjacent the bottom surface 13, wherein light from the illumination device 14 can be radiated onto the wafer 42. The light is reflected from the wafer and directed through the reading window 12 onto optical components provided inside the housing 11, which image and read or decode the scribe marks on the wafer 42, as described more fully below.

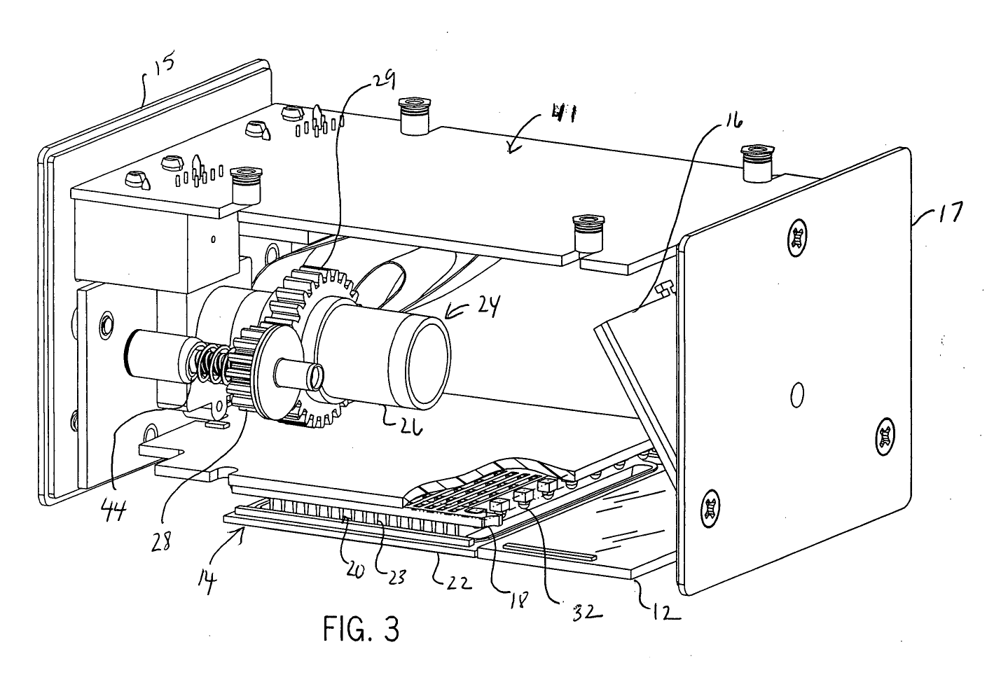

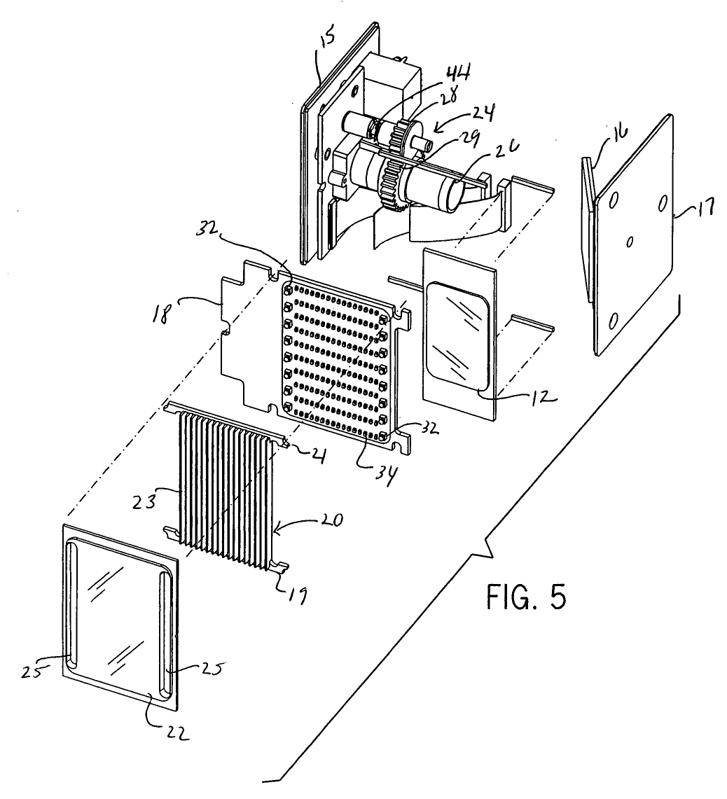

Referring now to FIGS. 3 and 5, the illumination device 14 includes an illumination board 18, a baffle assembly 20, and a plastic cover 22. The illumination board 18 is a printed circuit board with a plurality of rows of light emitting diodes (LEDs) which, when properly positioned in the housing 11, extend across the housing 11 from side 19 to side 21. Rows of bright field LEDs 34 are provided in a center portion of the board 18, and rows of dark field LEDs 32 are provided on opposing ends of the illumination board 18 adjacent the outer rows of bright field LEDs 34.

Referring still to FIGS. 3 and 5, the baffle assembly 20 comprises a plurality of baffles 23, extending between and perpendicular to connectors 19 and 21 provided at opposing ends of the assembly 20. There are a sufficient number of baffles 23 in the assembly 20 to provide one baffle between each adjacent row of bright field LEDs 34 and to separate the outer row of bright field LEDs 34 from the adjacent dark field LEDs 32. The baffles 23 are therefore sized and dimensioned to be received between adjacent rows of LEDs 34, and are further dimensioned to provide an opaque “wall” of sufficient height to limit the dispersion of light from the sides of the LEDs 34 such that illumination from the LEDs 34 is directed straight ahead, perpendicular to the board 18 and to the bottom surface 13 of the housing 11, thereby providing bright field illumination. The dark field LEDs 32, however, emit diffuse, angled light, and are not directed specifically in a direction perpendicular to the illumination board 18. These lights, therefore, provide dark field illumination.

The cover 22 is sized in dimensioned to extend over the rows of bright field LEDs 34 and associated baffles 23, and is constructed of a transparent, preferably plastic material, selected to diffuse the light emitted by the bright field LEDs 34 to make the emitted light more uniform and to limit the appearance of “dots” within the light. Apertures 25 are provided on opposing sides of the cover 22, and are sized and dimensioned to allow the dark field LEDs 32 to extend through the cover 22, thereby maintaining the normal diffusion properties of the dark field LEDs 32.

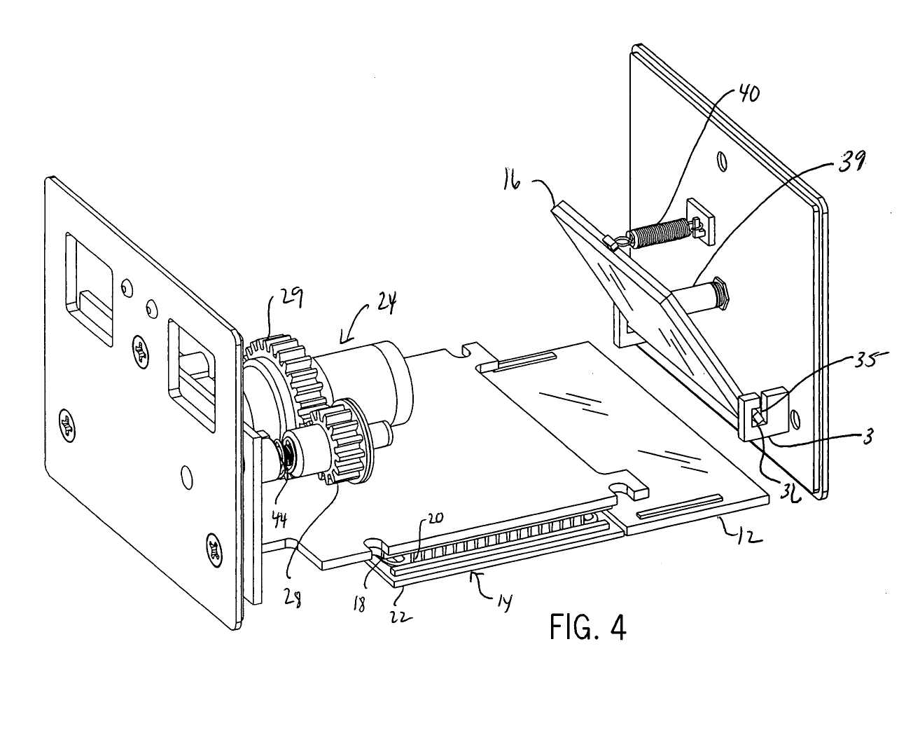

Referring still to FIGS. 3 and 5, and now also to FIG. 4, the reading window 12 comprises a glass, Plexiglas, plastic or other transparent material provided over an aperture cut into the bottom surface 13 of the housing 11. Light emitted through the reading window 12 is directed to a reflector 16, typically a mirror, coupled to a first end wall 17 of the housing 11. The reflected light is then directed along a camera axis 30 to a camera 24 that is mounted to the opposing end wall 15 of the housing 11.

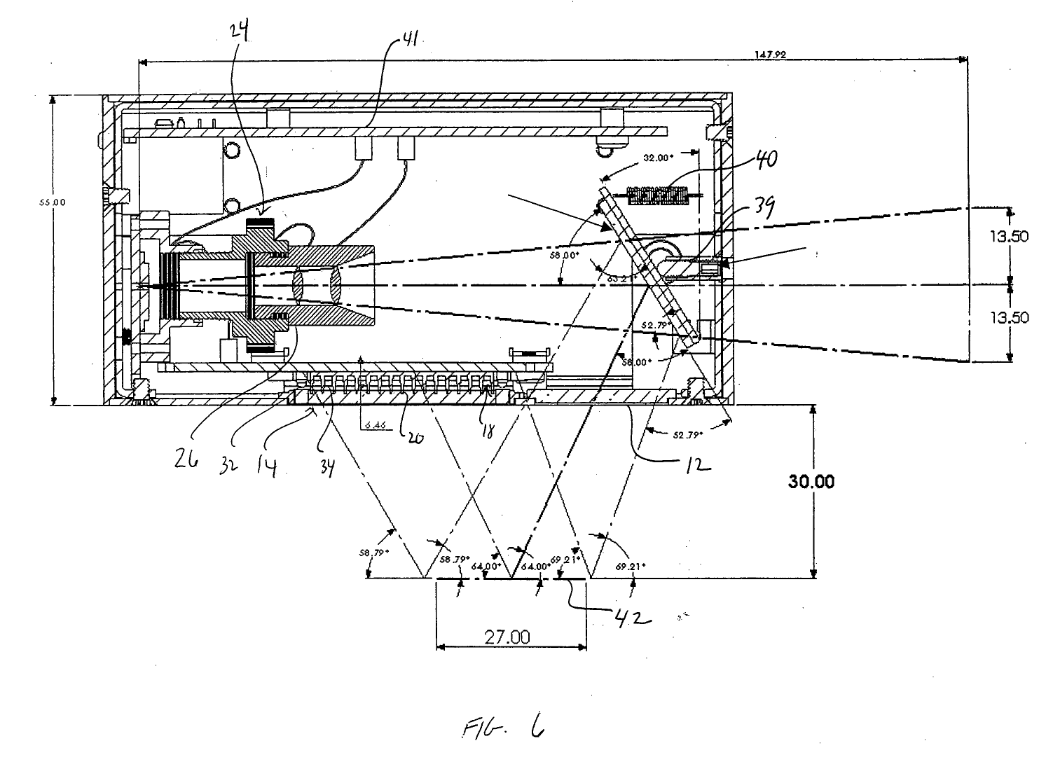

Referring still to FIGS. 3, 4, and 5 and now also to FIG. 6, the camera 24 includes a lens 26, an image sensor (not shown), and gears 28 and 29 for focusing the lens 26. As shown here, the gears 28 and 29 are adjustable by rotating a threaded fastener 44 which, in turn, rotates the gear 28, causing the gear 29 to focus the lens 26 in the camera 24. Although a threaded fastener 44 is shown for making this adjustment, the gears 28 can also be motor-driven, manually operated or otherwise controlled. The end of the threaded fastener 44 is accessible from outside the housing, such that the focus can be adjusted without removing the housing 11.

As described above, the camera 24 includes an image sensor such as a CMOS imaging sensor or CCD device, along with a processor which can, for example, include a microprocessor and/or digital signal processor provided on a control board 41 in the housing 11, as shown in FIG. 6. In a preferred embodiment, the image sensor is a high speed 1280×1024 CMOS sensor and the processor is a high speed digital signal processing device, such as a chip from the TI 64X family, commercially available from Texas Instruments of Dallas, Tex. The control board 41 includes software for decoding symbols such as one-dimensional barcode, data matrix, or other symbols. The control board 41 can also include software providing optical character recognition for identifying characters provided on the wafer 42.

Referring still to FIGS. 3-6, the reflector 16 is mounted to the end wall 17 of the housing 11 though a spring 40 and mounting bracket 38. The reflector 16 is typically a rectangular mirror, and includes pins 36 extending from opposing sides of the reflector body that are sized and dimensioned to be rotatably received in an aperture 35 provided in the mounting bracket 38, and therefore allow the mirror to be pivoted about the mounting brackets 38. A threaded connector 39 extends through the end wall 17 toward the reflector 16, and can be adjusted externally to the housing 11 to pivot the reflector 16 about the mounting bracket 38, and therefore to adjust the angle of the reflector 16, as described more fully below. To read a wafer positioned beneath the illumination device 14, the reflector is angled at an angle of greater than forty-five degrees. This angle is adjusted depending on the distance that a wafer is positioned beneath the bottom surface 13 of the reader 10 as described below.

Referring still to FIG. 6 and now also to FIG. 7, the reader 10 can be used for reading wafers 42 at varying distances from the bottom surface 13 of the housing 11, and is typically used in an automated manufacturing environment or similar application in which wafers are continually fed to a known position adjacent the reading window 12 for evaluation and decoding. Prior to use, the expected location for the wafer is determined, including the distance beneath the bottom surface 13 of the reader 10, and the reader 10 is adjusted to provide proper reflection and focus for the selected location. To properly adjust the reader, the threaded fastener 39 is rotated to adjust the angle of the reflector 16 to reflect light from the wafer 42 along the camera axis 30 to the lens 26 of the camera 24. The threaded fastener 44 can then be rotated, causing the gears 28 and 29 to rotate, adjusting the focus of the lens 26 of the camera 24 for the selected reading distance and location.

For the establishment of a proper optical path for illumination and light reflection, the wafer 42 is positioned directly below the bottom surface 13 of the housing 11, and parallel to the plane of the bottom surface 13. The wafer 42 is positioned beneath the bottom surface 13 of the reader 10 with the scribe or other mark to be read positioned directly below the illumination device 14, such that the bright field illumination is directed onto the wafer 42 by the bright field LEDs 34, which is directed by the baffles 23 toward the wafer 42 in a direction substantially perpendicular to the bottom surface 13 of the housing 11. Dark field illumination is provided by the rows of LEDs 32 at the opposing ends of the illumination board 18, which are not directed on the surface below and provide diffuse angled light onto the scribe or mark. Light reflected from the wafer 42 is received in the housing 11 through the reading window 12 by the reflector 16. The reflected light is then reflected by the reflector 16 along a camera axis 30 and toward the lens 26 of the camera 24. An image sensor in the camera 24 receives the reflected light, and the acquired image is decoded by a processing device and associated hardware provided on the control board 41.

Referring still to FIGS. 6 and 7, by way of example, in the embodiment shown here, the reader 10 can read wafers at distances between about twenty and forty millimeters below the bottom surface 13 of the housing 11. As shown here, the wafer is positioned thirty millimeters below the bottom surface 13 of the housing 11, and is about twenty-seven millimeters long (where this dimension is along the length of the reader 10) and thirty-six millimeters wide (along the width of the reader 10). The reflector 16 is angled at an angle of about fifty-eight degrees relative to the camera axis 30. Light from the illumination device 14 is reflected from the surface of the wafer 42 toward the reflector 16 at angles from about 58.79 degrees at the edge of the wafer furthest from the end wall 17 of the housing 11 to an angle of about 69.21 degrees at the edge closest to the end wall 17. At the approximate center of the wafer 42, the light is reflected toward the reflector 16 at an angle of about sixty-four degrees.

The invention therefore provides a method and apparatus for reading semiconductor wafers which is inexpensive, simple to construct and easy to adjust. It should be understood, however, that the methods and apparatuses described above are only exemplary and do not limit the scope of the invention, and that various modifications could be made by those skilled in the art that would fall under the scope of the invention. For example, although the invention is described for use in a semiconductor reader, it will be apparent that the principles described herein could be applied to various other reader applications. To apprise the public of the scope of this invention, the following claims are made:

1. An optical wafer reader comprising:
a camera having a camera axis substantially parallel to the wafer surface;
an illumination device disposed on the surface of the reader facing the wafer surface and aimed to illuminate a mark on the wafer with bright and dark field illumination;
a window in the surface of the reader facing the wafer surface for passage of light reflected off of the mark;
a reflector positioned to receive illumination reflected from the wafer and to direct the light along the camera axis.

2. The optical wafer reader of claim 1, wherein the illumination device comprises an array of light emitting diodes arranged in a plurality of rows.

3. The optical wafer reader as defined in claim 1, wherein a baffle is positioned between each of the adjacent rows of light emitting diodes adapted to direct the light emitted from the light emitting diodes to provide bright field illumination.

4. The optical wafer reader as defined in claim 3, further comprising at least one row of light emitting diodes adapted to provide dark field illumination.

5. The optical wafer reader as defined in claim 3, further comprising a cover positioned over the array of light emitting diodes producing bright field illumination.

6. The optical wafer reader as defined in claim 4, wherein the cover is constructed of a material selected to diffuse the light emitted by the light emitting diodes.

7. The optical wafer reader as defined in claim 1, further comprising a gear assembly for adjusting a focus of the camera.

8. The optical wafer reader as defined in claim 1, wherein the reflector is pivotally mounted to the housing opposite the camera.

9. The optical wafer reader as defined in claim 1, wherein the illumination reflected from the illumination device onto the surface of the wafer includes both bright field and dark field illumination.

10. The optical wafer reader as defined in claim 1, wherein the wafer is a semiconductor wafer including a scribe.

11. An optical wafer reader comprising:
a housing including a reader aperture positionable adjacent a wafer for reading a mark on the wafer;
a camera including a lens coupled to the a first end of the housing;
a mirror pivotally coupled to an opposing end of the housing and configurable to reflect light through the reader aperture toward the lens of the camera;
an array of light emitting diodes coupled to the housing adjacent the reader aperture and adapted to provide bright and dark field illumination to the wafer positioned below the illumination device, wherein light reflected from the wafer is reflected through the reader aperture to the mirror and by the mirror along a camera axis substantially parallel to the bottom surface of the reader.

12. The optical wafer reader of claim 11, further comprising an adjustment device external to the housing for adjusting the angle of the mirror.

13. The optical wafer reader of claim 11, further comprising a gear assembly for adjusting a focus of the camera.

14. The optical wafer reader of claim 11, wherein each of the rows in the array of light emitting diodes is separated from an adjacent row by a baffle.

15. The optical wafer reader of claim 11, wherein the gear assembly is adjustable by an adjustment device external to the housing.

16. The optical wafer reader of claim 11, further comprising a plastic cover sized and dimensioned to be positioned over a portion of the array of light emitting diodes to diffuse the bright field illumination.

17. An optical wafer reader comprising:
a housing having a reflector pivotally coupled to a first end and a camera coupled to an opposing end;
a light emitting device coupled to a bottom of the housing and adapted to illuminate a wafer to be read;
a reading aperture provided in the bottom of the housing adjacent the first end of the housing and adjacent the light emitting device;
wherein the reflector is pivotally adjustable to direct light reflected through the reading aperture along a camera axis parallel to the bottom surface of the housing and toward a lens of the camera.

18. The optical wafer reader as defined in claim 17, further comprising a gear assembly for adjusting a focus of the camera.

19. The optical wafer reader as defined in claim 17, wherein the illumination device comprises an array of light emitting diodes providing both dark and bright field illumination.

20. The illumination device as defined in claim 18, further comprising a threaded connector coupled to the first end of the housing and positioned to adjust the angle of the reflector when rotated.
